(19) United States
(12) Patent Application Publication
(10) Pub. No.: US 2025/0283758 A1
(43) Pub. Date: Sep. 11, 2025

(54) SPECTROSCOPIC MEASUREMENT DEVICE AND ARTICLE INSPECTION DEVICE INCLUDING THE SAME

(71) Applicant: ANRITSU CORPORATION, Kanagawa (JP)

(72) Inventors: Jyunichi SANO, Kanagawa (JP); Eiji TANIGUCHI, Kanagawa (JP); Shigeo ARAI, Kanagawa (JP)

(21) Appl. No.: 19/070,996

(22) Filed: Mar. 5, 2025

(30) Foreign Application Priority Data
Mar. 8, 2024 (JP) 2024-036154

(51) Int. Cl. G01J 3/02

(52) U.S. Cl. CPC G01J 3/0216; G01J 3/0237

(57) ABSTRACT

A spectroscopic measurement device includes a light source unit configured to irradiate a tablet with light, and a light detection unit configured to measure a spectral characteristic of transmission light transmitted through the tablet, in which the light source unit includes a condensing member configured to condense light emitted from a light source, the condensing member includes a first opening on which the light emitted from the light source is incident, a second opening formed to face the light detection unit and having an opening area smaller than an opening area of the first opening, and a transfer path configured to communicate the first opening and the second opening and transfer light entering the first opening to the second opening, and the transfer path has an inner dimension decreasing from the first opening toward the second opening and includes a wall surface consisting of a reflection surface.

### TECHNICAL FIELD

The present invention relates to a spectroscopic measurement device and an article inspection device.

### BACKGROUND ART

Patent Document 1 discloses a spectroscopic measurement device including a light irradiation unit that irradiates a placement surface on which an object to be measured is placed with broadband light from a light source via a light guide, and a light detection unit in which the light transmitted through the object to be measured is incident on a spectroscope via an optical fiber and which measures a spectral characteristic with the spectroscope, the spectroscopic measurement device further including a condenser lens that condenses the light from the light guide on a lower surface of the object to be measured.

### RELATED ART DOCUMENT

### Patent Document

[Patent Document 1] Japanese Patent No. 7270582

### DISCLOSURE OF THE INVENTION

### Problem That the Invention is to Solve

However, in the spectroscopic measurement device described in Patent Document 1, a condenser lens is used to condense the light from the light guide on the lower surface of the object to be measured, but with the condenser lens, it is not possible to sufficiently condense light emitted from an entire surface having a large area such as an end surface of the light guide, and there is still room for improvement in terms of light-condensing efficiency for the object to be measured.

In a case where the light-condensing efficiency for the object to be measured is increased, that is, in a case where energy per unit area of the light emitted to the object to be measured is increased, measurement accuracy for the object to be measured is also improved. However, in a case where efforts are made to increase the light-condensing efficiency with the condenser lens, a size of the condenser lens is required to be increased, which is not practical in a spectroscopic measurement device having a limited disposition space.

The present invention has been made in view of the above circumstances, and an object of the present invention is to provide a spectroscopic measurement device and an article inspection device capable of increasing light-condensing efficiency for an article without increasing a size.

### Means for Solving the Problem

A spectroscopic measurement device according to a first aspect of the present invention includes: a light source unit configured to condense light emitted from a light source with a condensing member and irradiate an article with the light; and a light detection unit configured to measure a spectral characteristic of transmission light transmitted through the article with a spectroscope, in which the condensing member includes a first opening on which the light emitted from the light source is incident, a second opening formed to face the light detection unit and having an opening area smaller than an opening area of the first opening, and a transfer path configured to communicate the first opening and the second opening and transfer light entering the first opening to the second opening, and the transfer path has an inner dimension decreasing from the first opening toward the second opening and includes a wall surface consisting of a reflection surface.

With the configuration, the spectroscopic measurement device according to the present invention includes the condensing member configured to condense the light emitted from the light source, in which the condensing member includes the first opening on which the light emitted from the light source is incident, the second opening formed to face the light detection unit and having the opening area smaller than the opening area of the first opening, and the transfer path configured to transfer the light entering the first opening to the second opening, and the transfer path has the inner dimension decreasing from the first opening toward the second opening and includes the wall surface consisting of the reflection surface.

Therefore, since the article is irradiated with the light, which is emitted from the light source, from the second opening having a small opening area while the light is reflected by the reflection surface of the transfer path, the light entering from the first opening having a large opening area can be efficiently condensed toward the second opening.

As a result, it is possible to increase energy per unit area of the light emitted to the article via the second opening, and it is possible to increase light-condensing efficiency for the article.

In addition, since the spectroscopic measurement device according to the first aspect of the present invention uses the condensing member using the reflection surface, in a case where the energy per unit area of the light emitted to the article is the same, a size of the condensing member can be reduced as compared with a condenser lens, and thus output of the light emitted from the light source unit can be reduced.

In addition, in the spectroscopic measurement device according to a second aspect of the present invention, in the spectroscopic measurement device according to the first aspect, the reflection surface consists of a smooth mirror surface.

With the configuration, in the spectroscopic measurement device according to the second aspect of the present invention, since the reflection surface of the condensing member consists of a smooth mirror surface, the light entering the first opening from the light guide can be specularly reflected by the reflection surface, and the light entering the first opening from the light guide can be efficiently transferred to the second opening.

In addition, in the spectroscopic measurement device according to a third aspect of the present invention, in the spectroscopic measurement device according to the first aspect, the condensing member is configured such that a relative position with respect to a light-irradiated surface of the article is adjustable. In addition, in the spectroscopic measurement device according to a fourth aspect of the present invention, in the spectroscopic measurement device according to the second aspect, the condensing member is configured such that a relative position with respect to a light-irradiated surface of the article is adjustable.

With the configuration, in the spectroscopic measurement device according to the third and fourth aspects of the present invention, since the condensing member is configured such that the relative position with respect to the light-irradiated surface of the article is adjustable, the position of the condensing member can be changed to an optimal position according to a type of the article to be measured. Therefore, even in a case where the type of the article to be measured is changed, it is possible to increase the light-condensing efficiency for the article.

In addition, in the spectroscopic measurement device according to a fifth aspect of the present invention, in the spectroscopic measurement device according to the first aspect, the condensing member is configured to be replaceable according to a type of the article. In addition, in the spectroscopic measurement device according to a sixth aspect of the present invention, in the spectroscopic measurement device according to the second aspect, the condensing member is configured to be replaceable according to a type of the article. In addition, in the spectroscopic measurement device according to a seventh aspect of the present invention, in the spectroscopic measurement device according to the third aspect, the condensing member is configured to be replaceable according to a type of the article.

With the configuration, in the spectroscopic measurement device according to the fifth to seventh aspects of the present invention, since the condensing member is configured to be replaceable according to the type of the article to be measured, in a case where the article to be measured is changed to an article of a different type, the condensing member can be changed to one, in which the dimensions of the first opening, the second opening, and the transfer path are optimal for the article, according to, for example, the shape, the dimension, or the like of the article after the change. Accordingly, even in a case where the article to be measured is changed, it is possible to increase light-condensing efficiency for the article.

In addition, in the spectroscopic measurement device according to an eighth aspect of the present invention, in the spectroscopic measurement device according to the first aspect, the condensing member includes an opening cover configured to cover the second opening and transmit light passing through the second opening. In addition, in the spectroscopic measurement device according to a ninth aspect of the present invention, in the spectroscopic measurement device according to the second aspect, the condensing member includes an opening cover configured to cover the second opening light passing through the second opening.

With the configuration, in the spectroscopic measurement device according to the eighth and ninth aspects of the present invention, since the condensing member includes the opening cover that covers the second opening and transmits the light passing through the second opening, it is possible to prevent, for example, a foreign substance from entering the transfer path from an article side through the second opening. Accordingly, it is possible to prevent reflection efficiency from being lowered because of adhesion of the foreign substance to the reflection surface of the transfer path.

An article inspection device according to a tenth aspect of the present invention includes: the spectroscopic measurement device according to the first aspect; and an inspection unit configured to inspect a quality of the article based on the spectral characteristic measured by the spectroscope. An article inspection device according to an eleventh aspect of the present invention includes: the spectroscopic measurement device according to the second aspect; and an inspection unit configured to inspect a quality of the article based on the spectral characteristic measured by the spectroscope.

With the configuration, since the article inspection device according to the tenth and eleventh aspects of the present invention includes the spectroscopic measurement device capable of increasing the light-condensing efficiency for the article, it is possible to prevent inspection accuracy of the inspection unit for the quality of the article from being lowered.

In addition, in the spectroscopic measurement device according to the tenth aspect, the article inspection device according to a twelfth aspect of the present invention further includes: a transport unit configured to hold the article on an end surface different from an irradiation-side surface and a transmission-side surface of the article and move the article in a state in which the irradiation-side surface and the transmission-side surface are exposed. In addition, in the spectroscopic measurement device according to the eleventh aspect, the article inspection device according to a thirteenth aspect of the present invention further includes: a transport unit configured to hold the article on an end surface different from an irradiation-side surface and a transmission-side surface of the article and move the article in a state in which the irradiation-side surface and the transmission-side surface are exposed.

With the configuration, in the article inspection device according to the twelfth and thirteenth aspects of the present invention, since there is no object that blocks the irradiation-side surface, to which the light from the light source unit is emitted, and the transmission-side surface, through which the transmission light passes, in the article being transported, the inspection can be performed with higher accuracy.

### Advantage of the Invention

According to the present invention, it is possible to provide a spectroscopic measurement device and an article inspection device capable of increasing light-condensing efficiency for an article without increasing a size.

### BRIEF DESCRIPTION OF THE DRAWINGS

FIG. 1 is a schematic configuration diagram of an article inspection device including a spectroscopic measurement device according to an embodiment of the present invention.

FIG. 2 is a schematic view for describing an action of a condensing member of the spectroscopic measurement device according to the embodiment of the present invention.

### BEST MODE FOR CARRYING OUT THE INVENTION

Hereinafter, an article inspection device including a spectroscopic measurement device according to an embodiment of the present invention will be described with reference to the drawings.

In a case where an article to be inspected, which is individually transported by a transport unit through a transport passage, reaches a predetermined inspection position, the article inspection device according to the present embodiment irradiates the article, which is in a certain posture, with light at the predetermined inspection position, and inspects a quality of the article based on a spectral characteristic of transmission light transmitted through the article in association with the irradiation of the light (also referred to as irradiation light).

The article to be inspected is an article having a size relatively close to an area irradiated with light, and includes an article having an outer diameter σ: several mm to several tens mm, which can be individually transported without being packaged, an article having a bite size, and an article or molded product having a predetermined shape and manufactured by existing manufacturing equipment or manufacturing equipment without an inspection function, particularly an article whose shape does not change in a transport process.

Examples of the article include a preparation, such as a tablet, a capsule, a troche, and a drop, a candy, chocolate, and the like. Hereinafter, as the article to be inspected, a tablet W having a circular shape in a plan view and a substantially columnar shape in a side view having a small height (thickness) compared to a diameter will be described as an example. The article to be inspected is not limited to a circular shape in a plan view, and articles having various shapes such as an elliptical shape and a polygonal shape can be applied.

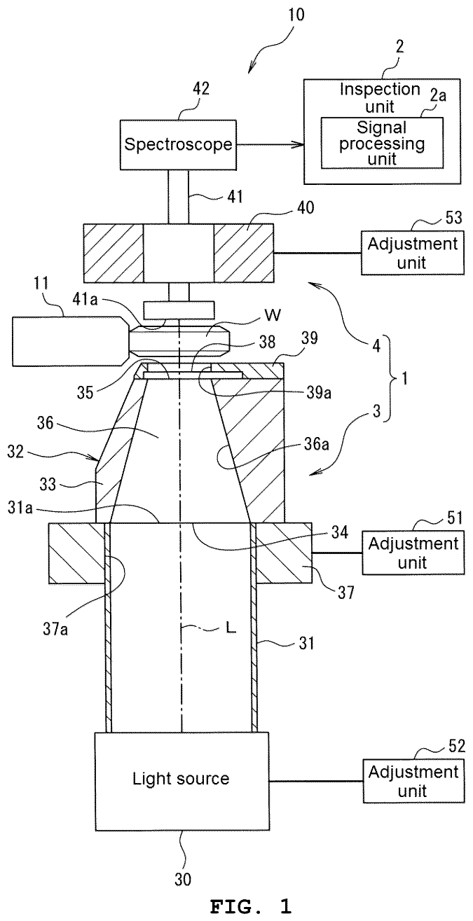

In addition, examples of the transport unit include a transport unit having a configuration in which articles are aligned and individually transported, such as a transport belt, a transport disk, and a transport chute. In the present embodiment, an example in which a transport disk 11 (refer to FIG. 1) is used as the transport unit will be described.

As shown in FIG. 1, the transport disk 11 is a transport unit having a configuration in which the tablet W is sucked to a suction hole on an outer peripheral surface thereof and transported in a circumferential direction while being laterally rotated. In the transport disk 11, the tablet W is transported in a state where an upper surface and a lower surface are horizontally maintained by a side surface being sucked to the suction hole. In FIG. 1, only a part of an outer peripheral side of the transport disk 11 is shown.

An article inspection device 10 according to the present embodiment includes a spectroscopic measurement device 1 and an inspection unit 2.

### Spectroscopic Measurement Device

The spectroscopic measurement device 1 includes a light source unit 3 and a light detection unit 4. The spectroscopic measurement device 1 irradiates the tablet W to be measured with broadband light (visible light and near-infrared to terahertz light (terahertz waves)), and measures a spectral characteristic of light transmitted through the tablet W in association with the irradiation of the light.

### (Light Source Unit)

The light source unit 3 irradiates the tablet W passing through a predetermined inspection position, that is, the tablet W during transportation (movement) with broadband light. In the present embodiment, the light source unit 3 is disposed on a side opposite to the light detection unit 4 (in the present embodiment, a lower side) with a transport passage of the tablet W interposed therebetween such that the light source unit 3 emits light from one side (in the present embodiment, the lower side) of a pair of circular end surfaces of the tablet W having a substantially columnar shape toward the other side (in the present embodiment, an upper side).

The transport passage of the tablet W is a region through which the tablet W passes during transportation. In addition, the predetermined inspection position is a position at which the light source unit 3 and the light detection unit 4 are disposed in the transport passage of the tablet W.

The light source unit 3 includes a light source 30, a light guide 31, and a condensing member 32.

The light source 30 is configured with a broadband light source represented by, for example, a halogen lamp in order to irradiate the tablet W to be measured with broadband light, and is provided at a predetermined position as a light source unit that is integrally assembled with a case in which lamp holding means and a heat dissipation fin (not shown) are formed, and is connected to a power supply unit (neither of which shown).

The broadband light refers to light including visible light and near-infrared to terahertz light (terahertz waves). It should be noted that a wavelength of light to be irradiated does not need to cover all of the above, and for example, in a wavelength band of 400 to 2500 nm, an object to be measured such as a tablet is likely to be transmitted, and damage due to ultraviolet rays is unlikely to be applied, and thus the wavelength may be limited to the wavelength band or a near-infrared band within the wavelength band. In addition, in a case where an absorption spectrum of a component to be measured is known, only a wavelength range corresponding to the absorption spectrum may be used.

The light guide 31 is configured by bundling a large number of glass optical fibers, and guides the light from the light source 30 to the condensing member 32 that condenses the light. The light emitted from the light source 30 is emitted to the tablet W via the light guide 31 and the condensing member 32.

The light guide 31 includes a distal end surface 31a facing the condensing member 32 at an end portion on a side opposite to the light source 30 (in the present embodiment, an upper side). The light emitted from the light source 30 is emitted from the distal end surface 31a of the light guide 31 toward the condensing member 32. In the present embodiment, the distal end surface 31a means a distal end surface of a light guide in which glass optical fibers are bundled in a bundle shape, and does not include an outer peripheral portion that covers the distal end surface.

The condensing member 32 is disposed on a distal end surface 31a side of the light guide 31, and specifically, is disposed above the distal end surface 31a of the light guide 31. The condensing member 32 is a member that condenses light emitted from the distal end surface 31a of the light guide 31 on the tablet W (in the example of FIG. 1, also referred to as the lower surface of the tablet W and an irradiation-side surface) at the predetermined inspection position.

The condensing member 32 includes a main body block 33, a first opening 34, a second opening 35, a transfer path 36, and an opening cover 38.

The main body block 33 is placed on an upper surface of a base member 37 and is fixed to the base member 37 by fastening means (not shown). The main body block 33 may be formed integrally with the base member 37.

The base member 37 has a through-hole 37a through which the light guide 31 passes, and a relative position with respect to the light guide 31 is adjustable. In the present embodiment, preferably, the position of the base member 37 is adjusted to be a position in which the first opening 34 of the condensing member 32 matches the distal end surface 31a of the light guide 31 in a horizontal direction (a direction perpendicular to a vertical direction in FIG. 1) and the first opening 34 and the distal end surface 31a face each other with a desired gap (including the gap=0) therebetween.

The first opening 34 is formed on a surface of the main body block 33 on the side of the distal end surface 31a of the light guide 31 (in the present embodiment, a lower surface) to face the distal end surface 31a. It is desirable that a diameter (inner diameter) of the first opening 34 is at least equal to or greater than a diameter of the distal end surface 31a of the light guide 31, and it is more preferable that the diameter of the first opening 34 is equal to the diameter of the distal end surface 31a of the light guide 31. However, the diameter (inner diameter) of the first opening 34 may be smaller than the diameter of the distal end surface 31a. The light emitted from the light source 30 is incident on the first opening 34.

The second opening 35 is formed on a surface of the main body block 33 on a light detection unit 4 side (in the present embodiment, an upper surface) to face the light detection unit 4. A diameter (inner diameter) of the second opening 35 is smaller than the diameter (inner diameter) of the first opening 34. Therefore, an opening area of the second opening 35 is smaller than an opening area of the first opening 34.

The transfer path 36 is formed in the main body block 33 to communicate the first opening 34 and the second opening 35, and transfers the light entering the first opening 34 from the light guide 31 to the second opening 35.

The transfer path 36 is formed in a shape in which an inner diameter as an inner dimension gradually decreases from the first opening 34 toward the second opening 35, for example, a frustum shape. The transfer path 36 is not limited to the frustum shape as long as the inner diameter gradually decreases from the first opening 34 toward the second opening 35, and may have, for example, another shape such as a curved surface shape, a bullet shape, and a parabolic shape.

The inner diameter of the transfer path 36 is a diameter of a cross section of the transfer path 36 perpendicular to an optical axis L of the light source 30, and in the present embodiment, is a diameter of the transfer path 36 in the horizontal direction.

The transfer path 36 consists of a reflection surface of which a wall surface 36a reflects light, and includes a smooth mirror surface.

The opening cover 38 is provided on a surface of the main body block 33 on the light detection unit 4 side (in the present embodiment, the upper surface) to cover the second opening 35. The opening cover 38 includes a transparent member, such as glass, that transmits light passing through the second opening 35. The opening cover 38 may not be provided.

The opening cover 38 is fixed to a surface of the main body block 33 on the light detection unit 4 side by a sealing member 39. The sealing member 39 is fixed to the main body block 33 by fastening means (not shown). An opening 39a is formed in the sealing member 39, and the light transmitted through the opening cover 38 from the second opening 35 passes through the opening 39a. The opening 39a preferably has a diameter equal to or larger than at least the diameter of the second opening 35, and it is more preferable that the opening 39a is formed to have the same shape and the same diameter as the second opening 35.

### (Light Detection Unit)

The light detection unit 4 includes an optical fiber 41 and a spectroscope 42. The light detection unit 4 is a unit in which the optical fiber 41 and the spectroscope 42 are supported by a base member 40.

The light detection unit 4 is disposed on a side opposite to the light source unit 3 (in the present embodiment, the upper side) with the transport passage of the tablet W interposed therebetween such that the light detection unit 4 faces an end surface (also referred to as a transmission-side surface) on the other side (in the present embodiment, the upper side) of a pair of circular end surfaces of the tablet W having the substantially columnar shape.

The optical fiber 41 receives transmission light transmitted through the tablet W at the predetermined inspection position. The transmission light transmitted through the tablet W is incident on the optical fiber 41 from an end surface (hereinafter, referred to as an “light-reception end”) 41a of an incidence surface of the optical fiber 41. The transmission light incident on the optical fiber 41 passes through the optical fiber 41 and reaches the spectroscope 42.

The spectroscope 42 performs, for example, spectral separation through a grating using a difference in a diffraction angle depending on the wavelength of light. Specifically, the light entering the spectroscope 42 is emitted to the grating (diffraction grating) and is spectrally separated into wavelength components. Then, the light spectrally separated into the wavelength components is detected by light detection elements arranged in one row for each wavelength component. Then, light intensity for each wavelength component is measured. The grating is an optical element in which a plurality of grooves are engraved on a surface.

As the optical fiber 41, a tapered optical fiber having a shape in which a diameter of an input is large and a diameter of an output is small can be used. As a result, the transmission light can be more efficiently incident on the spectroscope 42.

As described above, the light detection unit 4 receives the transmission light, which is emitted from the light source unit 3 and is transmitted through the tablet W, with the optical fiber 41, and measures the spectral characteristic of the transmission light received by the optical fiber 41 with the spectroscope 42.

### Inspection Unit

The inspection unit 2 has a signal processing unit 2a that performs signal processing on the spectral characteristic obtained by the light detection unit 4 within a predetermined exposure time, and inspects a quality of the tablet W, that is, performs good/bad determination of the quality of the tablet W from a result of the signal processing.

The signal processing unit 2a calculates a spectral characteristic in an absorbance of the tablet W from the spectral characteristic obtained by the light detection unit 4. Specifically, an absorbance A at a wavelength A is obtained by an equation A=−log10 (I/Ii) of a common logarithm of a ratio of light intensity Ii of incident light to light intensity I of the transmission light (transmittance), and a transmission amount detected in a state where the tablet W is not present at the predetermined inspection position can be obtained as the light intensity Ii of the incident light.

The inspection unit 2 compares a spectral characteristic (intensity of each wavelength of the spectrum (including a case of being differentiated multiple times), a shape of a waveform, information obtained by extracting the entire or a part of a region and providing a calibration curve thereof, and statistical information) in an absorbance of a good product of the tablet W acquired in advance with the spectral characteristic in the absorbance of the tablet W to be inspected, which is transported to the predetermined inspection position, and determines whether or not the quality of the tablet W is good based on the magnitude of a difference thereof. The inspection unit 2 outputs a selection signal based on a good/bad result of the determination to a selection unit (not shown) that selects the tablet W as a normal product or a defective product.

Specifically, whether or not the quality of the tablet W is good is determined, for example, based on whether or not a differential amount for each wavelength defined by calculation using a calibration curve obtained by a statistical calculation result (such as standard deviation), a statistical method such as regression analysis, or the like is within a predetermined range (a range defined based on a statistical calculation result or a result of calibration curve). In addition, it is also possible to determine whether or not the quality of the tablet W is good based on whether or not total intensity of wavelengths is within a predetermined range. Further, in a case where the components of the tablet W are uniform, whether or not the quality of the tablet W is good may be determined based on whether or not there is intensity exceeding a predetermined threshold value set in advance in a region other than a specific wavelength.

### Regarding Action of Condensing Member

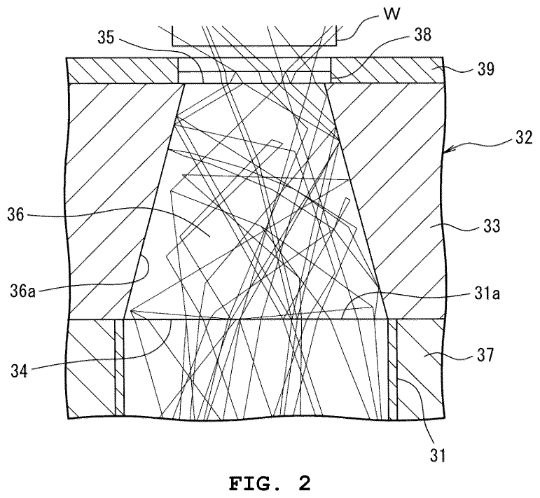

Next, an action of the condensing member 32 of the present embodiment will be described with reference to FIG. 2. Thin solid lines shown in FIG. 2 indicate an optical path of the light emitted from the distal end surface 31a of the light guide 31.

As shown in FIG. 2, the light emitted from the distal end surface 31a of the light guide 31 enters the transfer path 36 from the first opening 34 of the condensing member 32 as shown by the thin solid lines in FIG. 2. The light entering the transfer path 36 from the first opening 34 is specularly reflected from the wall surface 36a of the transfer path 36 or is repeatedly specularly reflected, and is efficiently transferred to the second opening 35 having the smaller opening area than that of the first opening 34. In this way, in the transfer path 36, the light entering the transfer path 36 is condensed and transferred to the second opening 35. The light transferred to the second opening 35 passes through the opening cover 38 and is incident on the lower surface of the tablet W.

In this case, the light transferred to the second opening 35 has higher energy per unit area than that of the light incident on the first opening 34. Therefore, the light incident on the lower surface of the tablet W has higher energy per unit area than that of the light emitted from the distal end surface 31a of the light guide 31.

### Regarding Adjustment Unit

The spectroscopic measurement device 1 of the present embodiment is configured such that relative positions between components, which are the condensing member 32, the light guide 31, and the light detection unit 4, are adjustable.

As shown in FIG. 1, the position of the base member 37 is adjusted by an adjustment unit 51, and thus the relative positions of the condensing member 32 with respect to the light guide 31 and the light detection unit 4 are adjusted. As a result, the relative positions of the condensing member 32 with respect to the light-irradiated surface of the tablet W (in the present embodiment, the lower surface) or the distal end surface 31a of the light guide 31 are adjustable. The adjustment unit 51 can adjust the position of the base member 37 in each of a direction perpendicular to the optical axis L (in the present embodiment, the horizontal direction) and a direction parallel to the optical axis L.

The position of the light source 30 is adjusted by an adjustment unit 52, and thus the relative positions of the light guide 31 with respect to the condensing member 32 and the light detection unit 4 are adjusted. The adjustment unit 52 can adjust the position of the light source 30 in each of the direction perpendicular to the optical axis L (in the present embodiment, the horizontal direction) and the direction parallel to the optical axis L. A position of the light guide 31 is also adjusted in conjunction with the adjustment of the position of the light source 30.

A position of the base member 40 is adjusted by an adjustment unit 53, and thus the relative positions of the light detection unit 4 with respect to the condensing member 32 and the light guide 31 are adjusted. The adjustment unit 53 can adjust the position of the base member 40 in each of the direction perpendicular to the optical axis L (in the present embodiment, the horizontal direction) and the direction parallel to the optical axis L.

The adjustment units 51, 52, and 53 may be any mechanism as long as the positions of the components can be adjusted automatically or manually, and for example, an adjustment mechanism such as a rack-and-pinion mechanism or a ball screw mechanism, or a combination thereof can be used. In a case of automatic adjustment, various actuators that drive the adjustment mechanism are further provided.

### Regarding Replacement of Condensing Member

In the spectroscopic measurement device 1 of the present embodiment, the condensing member 32 is configured to be replaceable according to a type of an article to be inspected (to be measured).

For example, in a case where the article to be examined (to be measured) is a tablet, the condensing member 32 having an optimum dimension can be selected and used according to a diameter of the tablet, a thickness of the tablet, and a shape of the tablet. For example, the condensing member 32 in which the diameter of the first opening 34, the diameter of the second opening 35, and a length of the transfer path 36 are optimal for the tablet to be inspected (to be measured) is selected according to a type of the tablet.

### Actions and Effects

As described above, the spectroscopic measurement device according to the present embodiment includes the condensing member 32 configured to condense the light emitted from the light source 30, in which the condensing member 32 includes the first opening 34 on which the light emitted from the light source 30 is incident, the second opening 35 formed to face the light detection unit 4 and having the opening area smaller than the opening area of the first opening 34, and the transfer path 36 configured to transfer the light entering the first opening 34 to the second opening 35, and the transfer path 36 has the inner diameter decreasing from the first opening 34 toward the second opening 35 and includes the wall surface 36a consisting of a reflection surface.

Therefore, in the spectroscopic measurement device according to the present embodiment, since the tablet W is irradiated with the light, which is emitted from the light source 30, from the second opening 35 having a small opening area while the light is reflected by the wall surface 36a of the transfer path 36, the light entering from the first opening 34 having a large opening area can be efficiently condensed toward the second opening 35.

As a result, in the spectroscopic measurement device according to the present embodiment, it is possible to increase the energy per unit area of the light emitted to the tablet W via the second opening 35, and it is possible to increase light-condensing efficiency for the tablet W.

In addition, since the spectroscopic measurement device according to the present embodiment uses the condensing member 32 using the reflection surface, in a case where the energy per unit area of the light emitted to the tablet W is the same, a size of the condensing member 32 can be reduced as compared with a condenser lens, and thus output of the light emitted from the light source unit 3 can be reduced.

In addition, in the spectroscopic measurement device according to the present embodiment, since the reflection surface of the condensing member 32 consists of a smooth mirror surface, the light entering the first opening 34 from the light guide 31 can be specularly reflected by the reflection surface, and the light entering the first opening 34 from the light guide 31 can be efficiently transferred to the second opening 35.

In addition, in the spectroscopic measurement device according to the present embodiment, since the condensing member 32 is configured such that the relative position with respect to the light-irradiated surface of the tablet W is adjustable, the position of the condensing member 32 can be changed to an optimal position according to a type of the tablet W to be measured. Therefore, even in a case where the type of the tablet W to be measured is changed, it is possible to increase the light-condensing efficiency for the tablet W.

In addition, in the spectroscopic measurement device according to the present embodiment, since the condensing member 32 is configured to be replaceable according to the type of the article to be measured, in a case where the article to be measured is changed to an article of a different type, the condensing member 32 can be changed to one, in which the dimensions of the first opening 34, the second opening 35, and the transfer path 36 are optimal for the article, according to, for example, the shape, the dimension, or the like of the article after the change. Accordingly, even in a case where the article to be measured is changed, it is possible to increase light-condensing efficiency for the article.

In addition, in the spectroscopic measurement device according to the present embodiment, since the condensing member 32 includes the opening cover 38 that covers the second opening 35 and transmits the light passing through the second opening 35, it is possible to prevent, for example, a foreign substance from entering the transfer path 36 from a tablet W side through the second opening 35. Accordingly, it is possible to prevent reflection efficiency from being lowered because of adhesion of the foreign substance to the reflection surface of the transfer path 36.

Since the article inspection device according to the present embodiment includes the spectroscopic measurement device 1 capable of increasing the light-condensing efficiency for the tablet W, it is possible to prevent inspection accuracy of the inspection unit 2 for the quality of the tablet W from being lowered.

### MODIFICATION EXAMPLE

In the present embodiment, the configuration in which the light source unit 3 includes the light guide 31 has been described, but a configuration in which the light source unit 3 does not include the light guide 31, that is, a configuration in which the light source unit 3 consists of the light source 30 and the condensing member 32 may be adopted.

In addition, in the present embodiment, the configuration in which the light detection unit 4 includes the optical fiber 41 has been described, but a configuration in which the light detection unit 4 does not include the optical fiber 41 or a configuration in which the light detection unit 4 consists of, for example, a Fourier transform infrared spectrometer (FTIR) that does not use an optical fiber may be adopted. In this case, a light source capable of emitting infrared light is used as the light source 30, and the tablet W is irradiated with infrared light. In addition, the light source unit 3 includes an interferometer consisting of a moving mirror, a fixed mirror, a beam splitter, and the like.

Although the embodiment of the present invention has been disclosed, it is apparent that modifications may be made by those skilled in the art without departing from the scope of the present invention. All such modifications and equivalents are intended to be included in the following claims.

### DESCRIPTION OF REFERENCE NUMERALS AND SIGNS

1: spectroscopic measurement device
2: inspection unit
2a: signal processing unit
3: light source unit
4: light detection unit
10: article inspection device
11: transport disk (transport unit)
30: light source
31: light guide
31a: distal end surface
32: condensing member
33: main body block
34: first opening
35: second opening
36: transfer path
36a: wall surface
37: base member
37a: through-hole
38: opening cover
39: sealing member
39a: opening
40: base member
41: optical fiber
41a: light-reception end
42: spectroscope
51, 52, 53: adjustment unit
L: optical axis
W: tablet (article)

What is claimed is:

1. A spectroscopic measurement device comprising:
a light source unit configured to condense light emitted from a light source with a condensing member and irradiate an article with the light; and
a light detection unit configured to measure a spectral characteristic of transmission light transmitted through the article with a spectroscope,
wherein the condensing member includes
a first opening on which the light emitted from the light source is incident,
a second opening formed to face the light detection unit and having an opening area smaller than an opening area of the first opening, and
a transfer path configured to communicate the first opening and the second opening and transfer light entering the first opening to the second opening, and
the transfer path has an inner dimension decreasing from the first opening toward the second opening and includes a wall surface consisting of a reflection surface.

2. The spectroscopic measurement device according to claim 1,
wherein the reflection surface consists of a smooth mirror surface.

3. The spectroscopic measurement device according to claim 1,
wherein the condensing member is configured such that a relative position with respect to a light-irradiated surface of the article is adjustable.

4. The spectroscopic measurement device according to claim 2,
wherein the condensing member is configured such that a relative position with respect to a light-irradiated surface of the article is adjustable.

5. The spectroscopic measurement device according to claim 1,
wherein the condensing member is configured to be replaceable according to a type of the article.

6. The spectroscopic measurement device according to claim 2,
wherein the condensing member is configured to be replaceable according to a type of the article.

7. The spectroscopic measurement device according to claim 3,
wherein the condensing member is configured to be replaceable according to a type of the article.

8. The spectroscopic measurement device according to claim 1,
wherein the condensing member includes an opening cover configured to cover the second opening and transmit light passing through the second opening.

9. The spectroscopic measurement device according to claim 2,
wherein the condensing member includes an opening cover configured to cover the second opening and transmit light passing through the second opening.

10. An article inspection device comprising:
the spectroscopic measurement device according to claim 1; and
an inspection unit configured to inspect a quality of the article based on the spectral characteristic measured by the spectroscope.

11. An article inspection device comprising:
the spectroscopic measurement device according to claim 2; and
an inspection unit configured to inspect a quality of the article based on the spectral characteristic measured by the spectroscope.

12. The article inspection device according to claim 10, further comprising:
a transport unit configured to hold the article on an end surface different from an irradiation-side surface and a transmission-side surface of the article and move the article in a state in which the irradiation-side surface and the transmission-side surface are exposed.

13. The article inspection device according to claim 11, further comprising:
a transport unit configured to hold the article on an end surface different from an irradiation-side surface and a transmission-side surface of the article and move the article in a state in which the irradiation-side surface and the transmission-side surface are exposed.
